(19) United States
(12) Patent Application Publication
(10) Pub. No.: US 2005/0259722 A1
(43) Pub. Date: Nov. 24, 2005

(54) Wireless clock system

(76) Inventors: Reginald Vanlonden, Sartell, MN (US); Bernhard Kopp, Weigheim (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/850,829

(22) Filed: May 21, 2004

(51) Int. Cl. H04B 1/707

(52) U.S. Cl. 375/145; 375/356

(57) ABSTRACT

A wireless clock system is disclosed. The system includes a primary clock device and at least one secondary clock device, where the secondary clock device is an analog clock, a digital clock, or a signal device. The primary clock device is adapted to wirelessly receive a reference time signal and wirelessly broadcast a master time signal based upon the reference signal to the secondary clock device. The secondary clock device wirelessly receives the signal and updates its displayed time accordingly. The secondary clock device can include a controller adapted to translate the wirelessly received signal into an alternate format recognized by a secondary clock device movement to synchronize the secondary clock device movement to the nearest second. The secondary clock device can further include an adapter module for compatibility with a wired clock system

### FIELD OF THE INVENTION

The invention relates generally to synchronized clock systems, and more particularly to a primary and secondary clock system capable of wireless synchronization and communication.

### BACKGROUND OF THE INVENTION

Clock systems comprising primary (master) and secondary (slave) clocks are generally known. These clock systems are typically installed in environments in which synchronization between one primary and centrally located clock and a plurality of locally geographically distributed secondary clocks is desired. For example, such clock systems are often used in schools, where the clock system may further comprise a bell or alert mechanism for signaling the start and end of class periods, and in airports, hospitals, and industrial work areas.

A significant drawback associated with distributed clock systems is the difficulty in maintaining synchronization between the primary clock and each of the secondary clocks. Diagnosing and correcting individual secondary clocks that are out of synchronization and compensating for power outages and Daylight Saving Time changes can be complicated and expensive to implement.

A second drawback associated with current distributed clock systems is installation. It can be costly and disruptive to hardwire a plurality of secondary clocks throughout a facility, particularly in large facilities such as airports, hospitals, and school campuses.

In many applications, it is also desired to synchronize the primary and secondary clocks with a verified time source. Examples of verified time sources include WWVB signals, cellular, global positioning system (GPS) signals, other satellite-based timing signals, or other geographically expansive, long-range radio frequency signals.

Modules for synchronization of individual clocks with long-range wireless signals, i.e., WWVB, cellular, or GPS, are available at nominal cost. A problem with such modules, however, is that building structures block or interfere with the signals. For example, in a school-wide clock system, the signals to individual internal classroom clocks from external time sources often will not reach these devices, and the devices therefore will not function properly.

Therefore, there is a need for a synchronized clock system that is easily installed, maintains synchronization with a verified time source, and is capable of communicating with system components distributed throughout a localized (i.e., square mile) geographic area.

### SUMMARY OF THE INVENTION

The invention disclosed herein is directed to a wireless clock system. In one embodiment as disclosed herein, the wireless clock system comprises a primary clock device and at least one secondary clock device, and typically a plurality or multiplicity of secondary clock devices. The at least one secondary clock device comprises an analog clock, a digital clock, or a chronologically controlled audio or visual signal device, or a combination of any of these devices.

In one embodiment of the wireless clock system, the primary clock device is adapted to wirelessly receive a long-range reference time signal, for example a GPS-based signal, maintain a master system time, broadcast the master time to the at least one secondary clock device to synchronize the at least one secondary clock device to the nearest second. In this embodiment, the primary clock device is further adapted to locally broadcast the master time to the at least one secondary clock device as a wireless spread spectrum signal in an available band, eliminating the requirement of an FCC site license for the wireless communications. The secondary clock device is adapted to receive the spread spectrum signal and synchronize as needed.

In another embodiment, the at least one secondary clock device further comprises an adapter operable to translate the master time signal received from the primary clock device into an alternate format recognized by a secondary clock device movement to synchronize the secondary clock device movement to the nearest second. The adapter receives a wireless spread spectrum signal broadcast by the primary clock device and translates the signal into a WWVB radio signal format to enable nearest second synchronization with a WWVB signal format compatible movement.

In yet another embodiment, the secondary clock receives a signal via a hardwired system and transmits the signal to the adapter, where the adapter is operable to translate the signal into a WWVB radio signal to enable nearest second synchronization with a WWVB signal format compatible movement.

In a further embodiment, the at least one secondary clock device is adapted to directly receive the long-range reference time signal. The secondary clock device is operable to synchronize with the long-range reference time signal or, in another embodiment, comprises an adapter to translate the signal into a signal format recognized by the secondary clock device movement.

An object and advantage of the system of the invention described herein is that, in one embodiment, the system wirelessly maintains synchronization with a reference time signal, reducing the maintenance costs typically associated with achieving and maintaining synchronization among a plurality of geographically distributed devices. The system is therefore relatively easy and inexpensive to install and maintain with respect to previous synchronized clock systems. In one embodiment, the system devices can be adapted for compatibility with hardwire installation systems for synchronization and power in one embodiment.

A further object and advantage of the system is that the secondary clock devices can be used either with or without the signal translation adapter, depending on whether a particular location of a secondary clock device is receptive to the long-range reference time signal. The system is also advantageous because the devices do not require hardwire installation for power or synchronization signals, but may be configured to receive such signals.

The above summary of the present invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a diagram of a wireless clock system in accordance with one embodiment of the present invention.

FIG. 2 is a block diagram of a primary clock device in accordance with one embodiment of the present invention.

FIG. 3 is a block diagram of a secondary clock device in accordance with one embodiment of the present invention.

FIG. 4 is a rear view of a secondary clock device movement in accordance with one embodiment of the present invention.

FIG. 5 is a first side view of secondary clock device movement of FIG. 4.

FIG. 6A is a second side view of the secondary clock device movement of FIG. 4.

FIG. 6B is a detail view of the secondary clock device movement of FIG. 6A.

FIG. 6C is a table of pin assignments corresponding to FIG. 6B.

FIG. 7 is a circuit schematic of a secondary clock controller in accordance with one embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

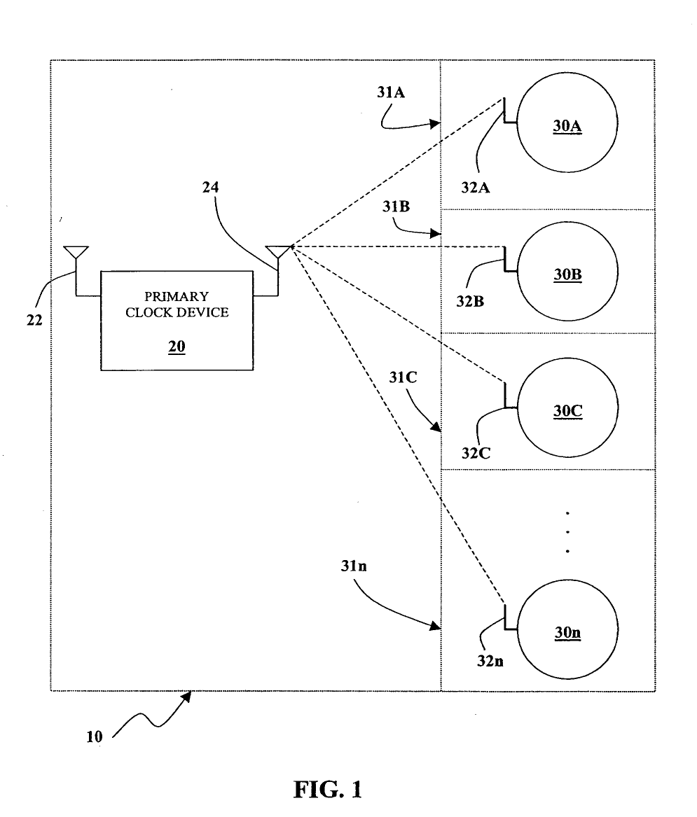

The wireless clock system of the present invention simplifies the synchronization process in clock systems, distributes a verified time, and reduces the costs associated with maintaining clock synchronization in a locally distributed clock system. The present invention can be more readily understood by reference to FIGS. 1-7 and the following description. While the present invention is not necessarily limited to such an application, the invention will be better appreciated using a discussion of exemplary embodiments in specific contexts.

The wireless clock system of the invention disclosed and described herein generally comprises a primary clock device and at least one secondary clock device. The system will typically comprise a plurality of secondary clock devices distributed throughout a local geographic area. The local geographic area may comprise a single building, a cluster of buildings, a campus, or a similar and relatively localized area in which a plurality of clocks are distributed and in which it is desired to maintain a uniform time among the plurality of clocks.

Referring to FIG. 1, a wireless clock system 10 in accordance with one embodiment of the present invention is depicted as a block diagram. The system 10 comprises a primary clock device 20 and a plurality of secondary clock devices 30A-n. The primary clock device 20 includes receiver circuitry comprising a receiver antenna 22 for wirelessly receiving a long-range reference time signal from an external source. For example, the reference time signal comprises a Global Positioning System-based (GPS) signal in one embodiment. In other embodiments, the reference time signal can also comprise other long-range wireless signal formats, including satellite system-based signals, WWVB or similar radio signals, cellular signals, a wirelessly transmitted computer or Internet-based time reference, or other long-range wirelessly transmitted reference signal formats as known to those skilled in the art. The receiver antenna 22 will typically be installed external to the building or structure in which the primary clock device 20 is located and coupled to the primary clock device 20 via a cable or wire to maximize reference signal receipt capability. If the primary clock device 20 is positioned near an external wall or in a location where reference signals can be received with success, the receiver antenna 22 can be directly mounted on the primary clock device 20 in other embodiments.

The primary clock device 20 further comprises a transmitter antenna 24 for wirelessly broadcasting a short-range localized system time signal based upon the received reference time signal to the plurality of secondary clock devices 30A-n to achieve and maintain system time synchronization. The transmitter antenna 24, like the receiver antenna 22, can be mounted directly to the primary clock device 20 or coupled to the primary clock device 20 via a wire or cable. The short-range system time signal broadcast by the primary clock device 20 to the secondary clock devices 30A-n will preferably comprise a spread spectrum transmission signal broadcast in the ISM band of 902-928 MHz. A spread spectrum signal is a signal that is transmitted over a broad range of frequencies and reassembled upon receipt. This signal format is preferred because it is robust yet does not require a user to obtain an FCC site license for signal transmission and broadcast within the system 10. An FCC license requirement can be time and cost prohibitive to users desiring to implement localized wireless clock systems.

The secondary clock devices 30A-n generally comprise analog clocks geographically distributed throughout a localized building, facility, cluster, or campus area. In one embodiment, the system 10 includes up to 250 or more secondary clock devices 30A-n. The secondary clock devices 30A-n can also comprise digital clocks and chronologically controlled audio or visual signal devices. For example, the system 10 can include one or more bell circuits synchronized by the primary clock device 20 for signaling class periods on a school campus. The secondary clock devices 30A-n are generally located in isolated areas 31A-n that are not receptive to the long-range signals received by the primary clock device 20 and thus receive short-range synchronization signals from the primary device 20. In one embodiment, the secondary clock devices 30A-n each include an antenna 32A-n for receiving the short-range signals broadcast by the primary clock device 20. The secondary clock device antennas 32A-n will generally be mounted directly on the secondary clock devices 30A-n, for example on the back of a wall-mounted analog clock, in an unobtrusive manner.

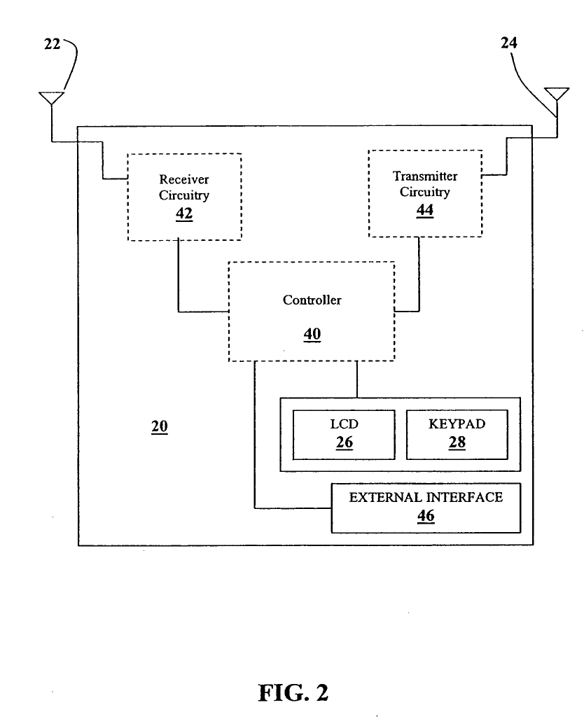

Referring to FIG. 2, the primary clock device 20 includes internal circuitry comprising receiver circuitry 42, transmitter circuitry 44, and a controller 40. The receiver circuitry 42 is in operable communication with the receiver antenna 22 to receive long-range reference time signal, initially process the signal, and communicate the signal to the controller 40. The controller 40 is microprocessor-based and includes an internal clock that maintains a master system time based upon the received reference time signal, synchronized to the nearest second. The controller 40 is in operable communication with transmitter circuitry 44 in turn communicating with the transmitter antenna 24 for wirelessly broadcasting a synchronization time signal to the secondary clock devices 30A-n in the system 10.

The primary clock device 20 further comprises an externally visible liquid crystal display (LCD) 26 for displaying the master system time maintained by the controller 40 and updated by the received long-range reference time signal. The primary clock device 20 is programmable via an external keypad 28 and the LCD 26, for example for programming and scheduling the bell circuits or other secondary clock devices 30A-n or manually entering a system time if a long-range wireless reference time signal is unavailable or for some reason undesired. The controller 40 is further capable of being programmed to provide automatic standard and Daylight Saving Time changes and updates, independent of or in coordination with the long-range reference time signal, and updating the master time and system 10 time accordingly.

In another embodiment, the primary clock device 20 is network-connected at an external interface 46, enabling programming of the primary clock device 20 and system 10 via a computer or other network device (not shown). The reference time signal in these embodiments can be obtained from the network or from the Internet via the interface 46 if the network is so connected.

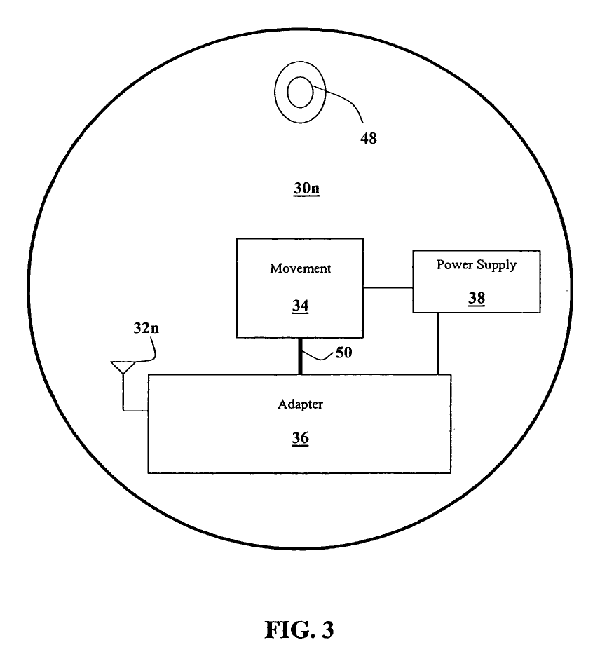

A secondary clock device 30n in accordance with one embodiment of the invention described herein is depicted in FIG. 3. The secondary clock device 30n comprises an analog clock adapted for wall mounting via a hanger 48, with the rear side of the clock 30n shown in FIG. 3. The secondary clock device 30n can also comprise a digital clock or other signal device, as previously described with reference to FIG. 1. In one embodiment, the secondary clock device 30n comprises an analog clock movement 34 in electrical communication with an adapter 36 via a connector 50, wherein the adapter is microcontroller-based and is in operable communication with an antenna 32n configured to receive wireless signals broadcast by the primary clock device 20. The movement 34 and adapter 36 are connected to a power supply 38. In one embodiment, the power supply 38 is included as part of the movement 34 and is operably coupled to the adapter 36. The power supply 38 is preferably a battery source for ease of installation and maintenance. The battery source can comprise a single long-life battery or a battery pack, but will preferably provide uninterrupted and maintenance-free power to the movement 34 and adapter 36 for at least five years. The secondary clock device 30n is generally encased in a housing of the type typically used for wall-mounted clocks.

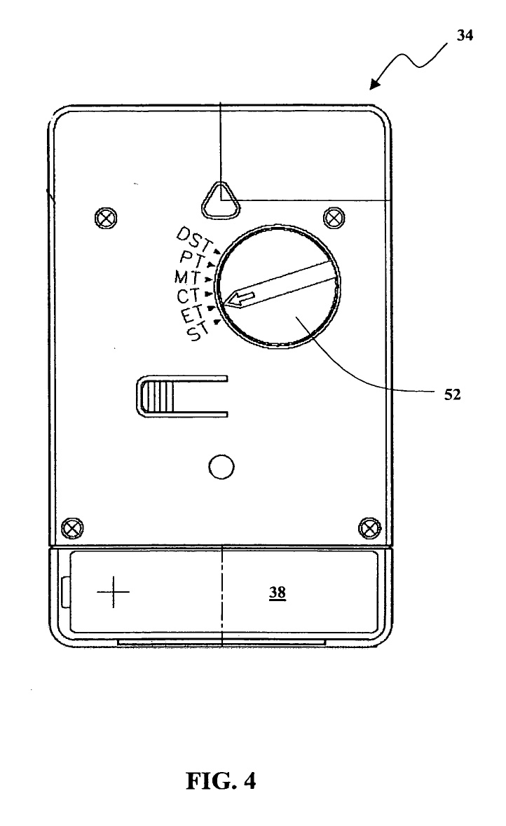

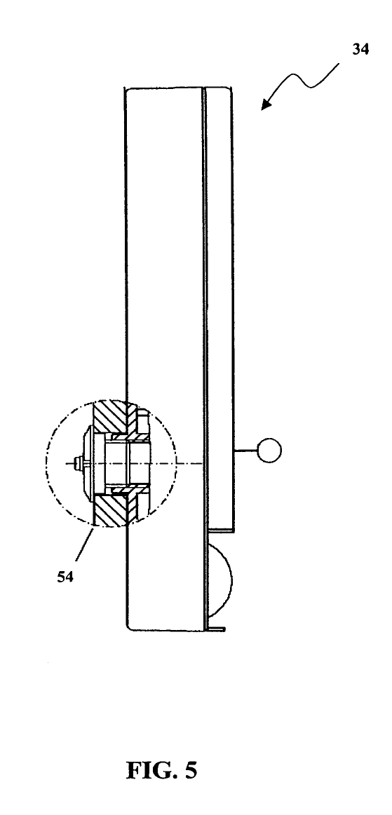

A movement 34 in accordance with one embodiment is depicted in FIG. 4. The rear side of the movement 34 is shown, as would be visible on the rear side of the secondary clock device 30n described above, and comprises an analog clock movement 54 shown in enlarged detail in FIG. 5. For example, a WWVB signal compatible analog movement by the German manufacturer HECHINGER can be implemented, although various commercially available analog clock movements can be used with the secondary clock device 30n, as will be recognized by those skilled in the art. The movement 34 optionally includes a manual time zone selector 52 by which a user can select the appropriate time zone or Daylight Saving Time (DST) mode. The selector 52 shown is configured for compatibility with North American time zones and can be labeled to correspond to European, Asian, or other world time zones in other embodiments. The movement 34 also includes a battery source power supply 38. The battery source power supply 38 can optionally power the adapter 36, although in other embodiments the power supply 38 can comprise a battery pack, or a separate power supply source or connection adapted to operably couple to the movement 34 and the adapter 36.

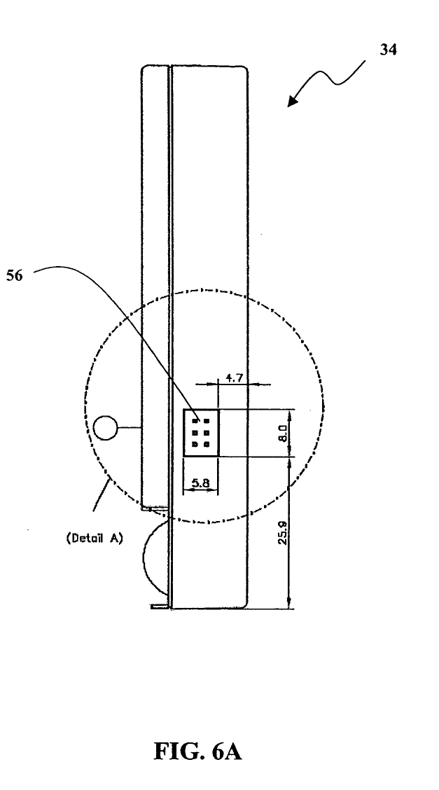

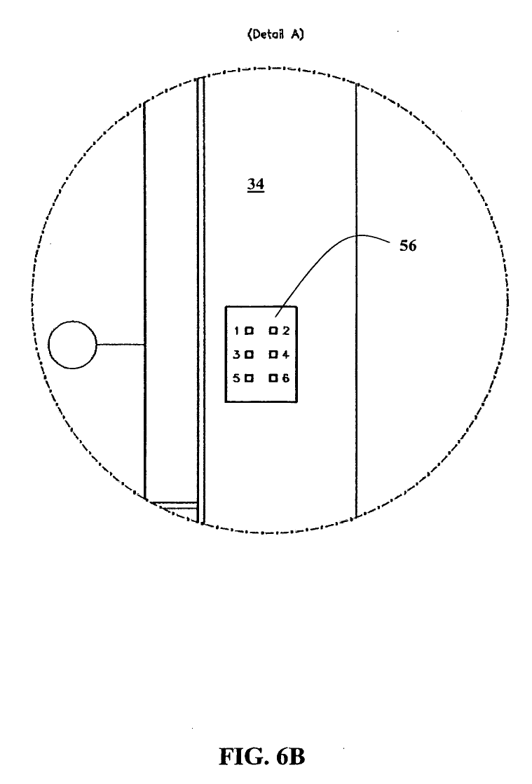

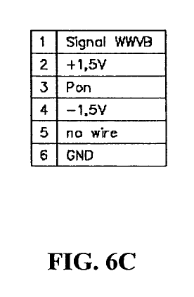

A second side view of the movement 34 is shown in FIG. 6A, in which the connector interface 56 is depicted. Interface 56 is adapted to couple the movement 34 to the adapter 36 via the connector 50. An enlarged detail view of the interface is shown in FIG. 6B, with corresponding pin assignments shown in the table of FIG. 6C.

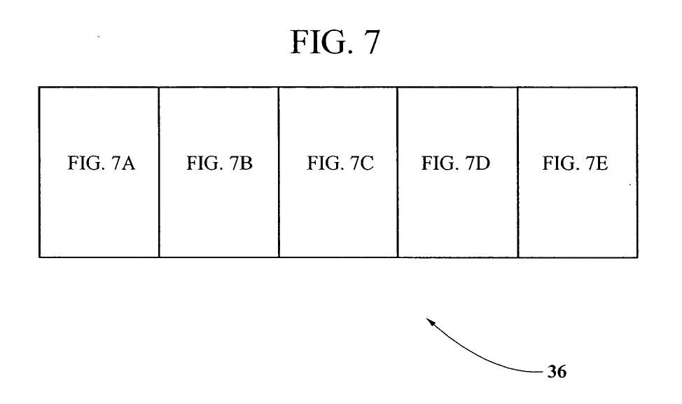

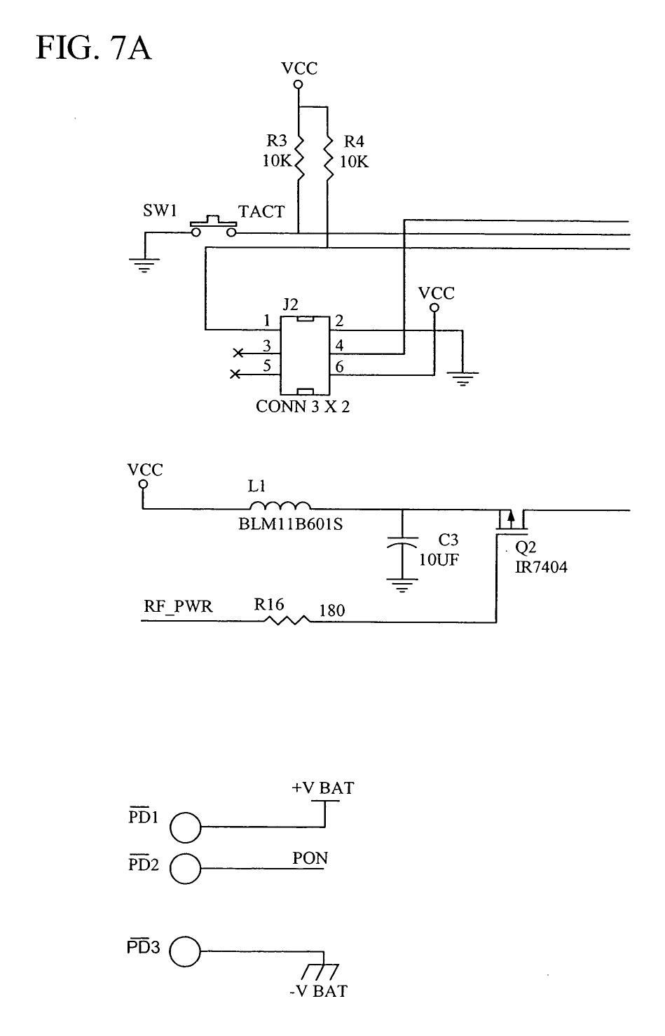

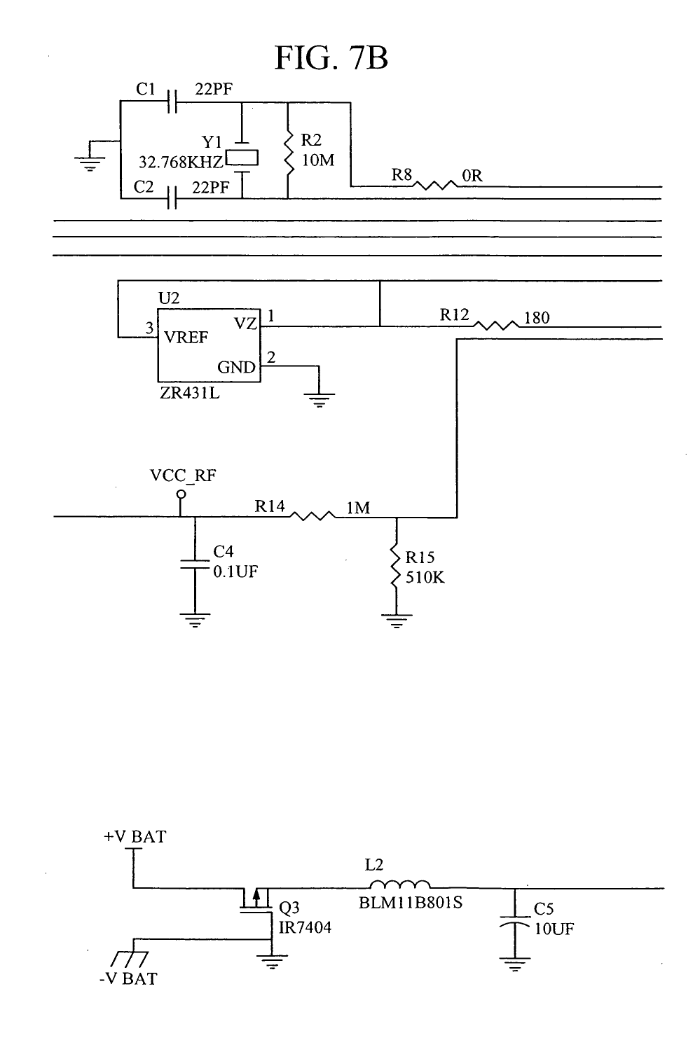

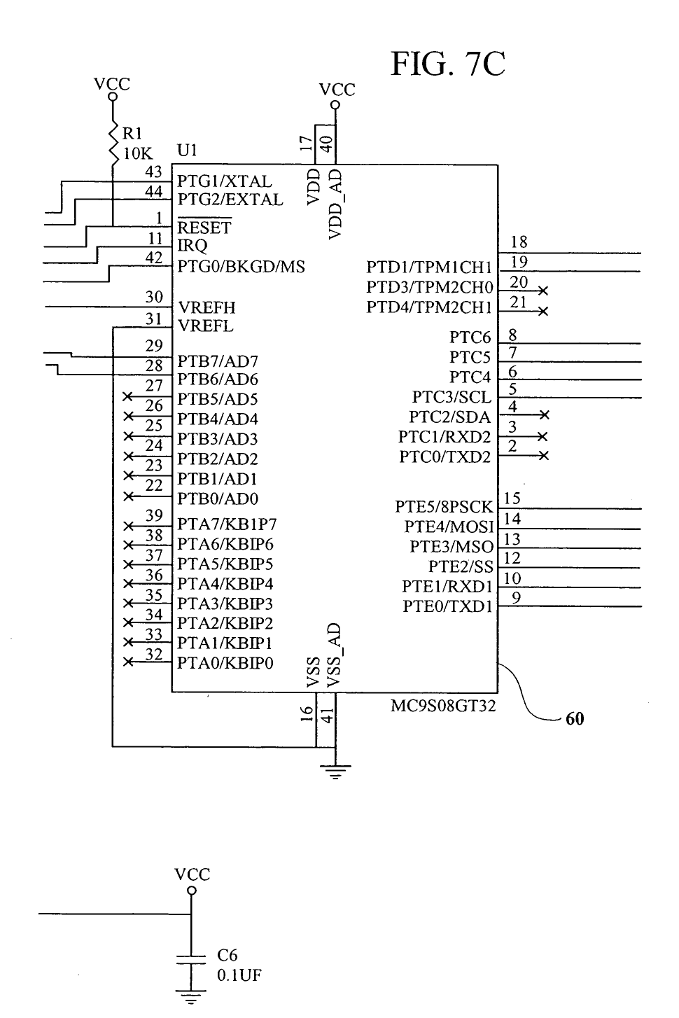

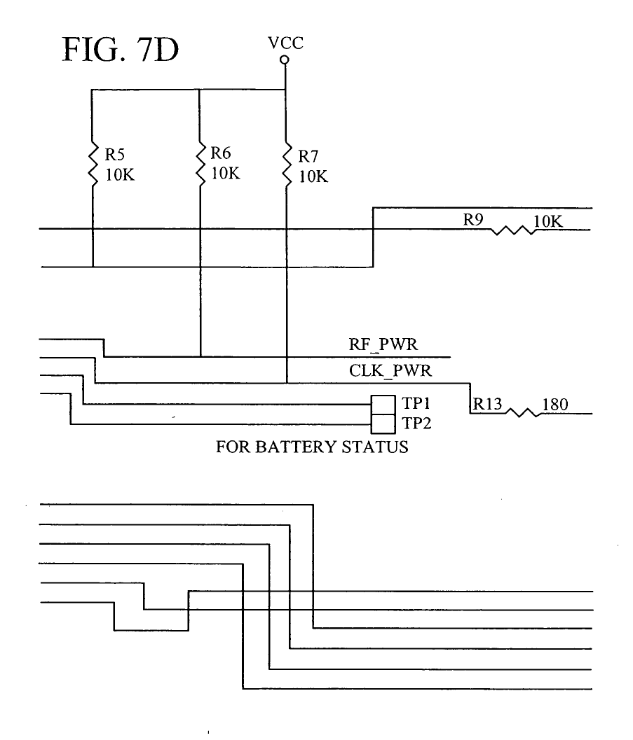

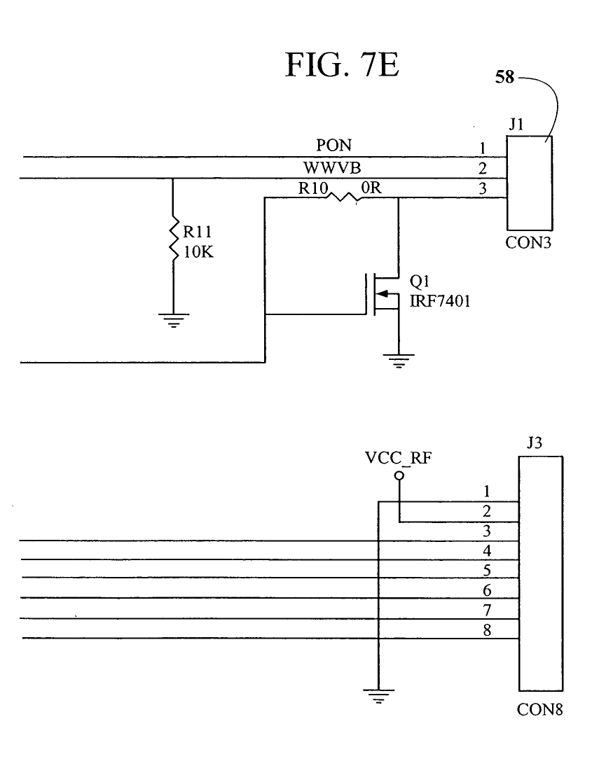

FIG. 7 is a schematic of the adapter 36. The adapter 36 includes a microcontroller 60 in electrical communication with the adapter interface 58 to connector 50. The adapter 36 is a module operable to translate a signal received from the primary clock device 20 into a signal format recognized by the movement 34 for synchronization. As previously described, the secondary clock device 30n receives via an antenna 32n a broadcast spread spectrum transmission from the primary clock device 20. The spread spectrum transmission is preferred because it eliminates the requirement of an FCC site license, as required by wireless clock systems using other signal rebroadcast formats. In one embodiment, the secondary clock device 30n, via the adapter 36 and the adapter microcontroller 60, comprises a signal translation function to enable synchronization communication with a clock movement 34 designed to receive signals of a format other than the format broadcast by the primary clock device 20, namely spread spectrum. For example, stand-alone radio-controlled clocks are generally known. A commercially available radio-controlled clock movement available from HECHINGER, for example, is designed to receive WWVB radio signals transmitted by the National Institute of Standards and Technology (NIST) in Colorado. To implement WWVB-controlled clock movements into the system 10 of the invention, the aforementioned signal translation function is implemented by the adapter 36 via the microcontroller 60.

The electrical interface of the signal translation function carried out by the adapter 36 is accomplished with a pin connector 50, which routes signals between the adapter 36, via interface 58, and the clock movement 34, via interface 56. Referring to FIGS. 6B and 6C, these signals comprise a PON signal (pin 3), a WWVB signal (pin 1), and ground (pin 6). The PON signal is a clock movement 34 output and when in a “low” logic state indicates that the movement 34 is looking for a WWVB signal on pin 1, the WWVB signal input, of the movement 34. PON is generally activated under two conditions: 1) when a Power On Reset (POR) occurs within the movement 34, and 2) when the movement 34 time of day is at one of four prescribed times (for example, 2:00 AM/PM and 8:00 AM/PM). PON may alternately be activated on demand or under other conditions as defined by the system 10 or selected by a user. The PON signal on pin 3 will generally remain active for some period of time, for example about twenty minutes in one embodiment, although typically a WWVB signal will be present on pin 1 when pin 3 transitions to an active state and PON will remain active only long enough for the movement 34 to “sync-up” with the WWVB signal. The adapter 36 uses pin 3 of the connector 50 to time the activation of its receiver associated with the antenna 32n. When the receiver is activated, it will look for a broadcast system time spread spectrum signal from the primary clock device 20. When this transmission is received, the adapter 36 will translate the received time signal into a WWVB format transmission in a synchronized time code at the microcontroller 60 and apply the synchronized time code to the WWVB signal input on pin 1 of the connector 50, thereby translating the received spread spectrum time signal transmission into the WWVB signal input format required by the movement 34 and transmitting the signal to the movement 34 for synchronization.

Specifically, a WWVB-compatible clock movement 34 may require a synchronizing input comprising a time code synchronized with a 60 kHz carrier and broadcast continuously at a rate of one bit per second using Pulse Width Modulation (PWM). The time code is sent in binary coded decimal (BCD) format with the most significant bit sent first. Carrier power is reduced 10 dB at the start of each second; if power is restored 200 ms later a 0-bit is represented, if power is restored 500 ms later a 1-bit is represented, and if power is restored 800 ms later a reference or position bit is represented. Upon receipt of the broadcast time signal from the primary clock device 20, the microcontroller 60 of the adapter 36 will translate and encode the signal in a recognized WWVB format and transmit the formatted and synchronized time code signal on the WWVB input pin 1 of the connector 50 to the clock movement 34. An encoding and transmitting algorithm implemented by the microcontroller 36 ensures that the transmission begins on the minute for system synchronization to the nearest second and that the PWM and BCD format as previously described is observed. The PWM is implemented using the same timings as the NIST WWVB signal; at the start of each second the WWVB signal is driven low and returned high according to which bit representation (0,1,Ref) is being transmitted. Ground is routed through the connector 50 so that the ground reference for both the movement 34 and the adapter 36 is the same.

The signal translation function described above can be implemented as required by the clock movement 34 to achieve and maintain system 10 synchronization to the nearest second. Other movements 34 can be used that require other similar signal translation formats, rather than from GPS-based spread spectrum to WWVB, with the adapter 36 and microcontroller 60 configured accordingly.

In one embodiment, the primary clock device 20 and secondary clock devices 30A-n are further capable of two-way wireless communications. The secondary clock device 30n further comprises transmitter circuitry in communication with the antenna 32n. Two-way communication between the primary clock device 20 and secondary clock devices 30A-n enables broadcast signal receipt and synchronization confirmation information to be sent from the secondary clock devices 30A-n to the primary clock device 20, allowing the primary clock device 20 to monitor the system 10 status and provide an alert if a secondary clock device 30A-n is unresponsive. Additional information, for example maintenance information including battery power status, could also be sent from the secondary clock devices 30A-n to the primary clock device 20. If a particular secondary clock device 30n is out-of-range or unable to receive a signal because of interference, a repeater device can be installed to relay the signal broadcast from the primary clock device 20 to synchronize the secondary clock device 30n with the system 10. In one embodiment, the repeater device is a stand-alone repeater module. In another embodiment, the repeater device comprises a fully operable secondary clock device 30n that further includes a repeater module operable to relay a signal to an out-or-range secondary clock device.

In operation, the system 10 is installed in a building, cluster, campus, or other facility. The primary clock device 20 is typically centrally located to maximize a communication radius, with the receiver antenna 22 located so as to successfully receive a GPS-based or other long-range reference time signal. One or a plurality of battery-powered secondary clock devices 30A-n are distributed as desired throughout the site in locations where each device 30A-n is capable of successfully receiving the broadcast time signal from the primary clock device 20. As the secondary clock devices 30A-n are installed and powered on, each is automatically calibrated and time-synchronized to the nearest second with the primary clock device 20, which has been powered on and synchronized via the long-range reference time signal. The secondary clock devices 30A-n thus do not require manual set-up. Depending upon the configuration of the system 10 and programming of the primary clock device 20, the primary clock device 20 broadcasts signals to the system 10 at set times, on demand, or intermittently.

In another embodiment, the system 10 comprises a hardwired clock system. The primary clock device 20 wirelessly receives a long-range reference time signal, for example a GPS-based signal or another signal as previously described, and transmits a synchronization signal to at least one secondary clock device 30n via a hardwired system. The secondary clock device 30n further comprises an adapter 36 in communication with circuitry interfacing the secondary clock device 30n with the hardwired clock system, wherein the adapter 36 receives the wired synchronization signals, translates the signals as necessary, and transmits the signals to the clock movement 34 for synchronization, thereby maintaining system 10 synchronization with the wirelessly received reference time signal.

In yet another embodiment, the adapter 36 is omitted from one or all of the secondary devices 30A-n in the system 10. In this embodiment, the clock movement 34 of a secondary device 30n in which the adapter 36 is omitted is configured to directly receive the synchronization signals broadcast by the primary clock device 20 and synchronize as necessary.

In yet another embodiment, at least one secondary clock device 30A-n is adapted and located in a building, cluster, or campus so as to directly receive the long-range reference time signal. In one embodiment, the secondary clock device 30n includes an adapter 36 operable to translate the received long-range reference time signal into a signal format recognized by the clock movement 34. In another embodiment, the secondary clock device 30n omits the adapter, wherein the clock movement 34 is adapted to directly receive the long-range reference time signal and synchronize accordingly.

Because numerous modifications of this invention may be made without departing from the spirit thereof, the scope of the invention is not to be limited to the embodiments illustrated and described. Rather, the scope of the invention is to be determined by the appended claims and their equivalents.

1. A wireless clock system comprising:
a primary clock device comprising receiver circuitry adapted to receive a long-range wireless reference time signal, a primary controller in electrical communication with the receiver circuitry and adapted to maintain a system time based upon the reference time signal, and transmitter circuitry in electrical communication with the primary controller and adapted to wirelessly broadcast the system time as a short-range spread spectrum signal; and
at least one secondary clock device comprising an adapter in electrical communication with a clock movement adapted to receive a synchronized time code, the adapter including receiver circuitry adapted to receive the system time spread spectrum signal and a microcontroller;
wherein the microcontroller is operable to encode a received short-range spread spectrum signal as a synchronized time code and transmit the synchronized time code to the clock movement, and wherein the clock movement is adapted to achieve system time synchronization after receiving the synchronized time code.

2. The system of claim 1, wherein the long-range wireless reference time signal comprises a global positioning system-based (GPS) signal.

3. The system of claim 1, wherein the short-range spread spectrum signal is broadcast in a band of about 902 megahertz to about 928 megahertz.

4. The system of claim 1, wherein the primary clock device further comprises a liquid crystal display (LCD) for displaying the system time.

5. The system of claim 4, wherein the primary clock device further comprises an external keypad for programming the primary clock device.

6. The system of claim 1, wherein the primary clock device further comprises an external computer interface for connection to a computer.

7. The system of claim 1, wherein the synchronized time code is a WWVB radio signal format.

8. The system of claim 1, wherein the at least one secondary clock device comprises an analog clock that includes an enclosure adapted for wall mounting, and wherein the clock movement comprises an analog clock movement including hour, minute, and second indicators.

9. The system of claim 1 further comprising a repeater device, the repeater device adapted to receive the short-range spread spectrum signal from the primary clock device and re-broadcast the received short-range spread spectrum signal to at least one secondary clock device.

10. The system of claim 1, wherein the at least one secondary clock device further comprises transmitter circuitry adapted to wirelessly transmit secondary clock device status information to the primary clock device.

11. A wireless clock system comprising:
a primary clock device adapted to receive a reference time signal, a primary controller adapted to maintain a system time based upon the reference time signal, and transmitter circuitry in electrical communication with the primary controller and adapted to wirelessly broadcast the system time as a short-range spread spectrum signal; and
at least one secondary clock device comprising an adapter in electrical communication with a clock movement adapted to receive a synchronized time code, the adapter including a microcontroller and receiver circuitry adapted to receive the short-range spread spectrum signal;
wherein the microcontroller is operable to encode a received short-range spread spectrum signal in a synchronized time code and transmit the synchronized time code to the clock movement, and wherein the clock movement is adapted to achieve system time synchronization after receiving the synchronized time code.

12. The system of claim 11, wherein the primary clock device further comprises an external computer interface for connection to a computer network, and wherein the reference time signal is received from the computer network.

13. The system of claim 12, wherein the computer network comprises the Internet.

14. The system of claim 13, wherein the synchronized time code is a WWVB radio signal format.

15. The system of claim 13, wherein the at least one secondary clock device further comprises transmitter circuitry adapted to wirelessly transmit secondary clock device status information to the primary clock device.

16. A method of synchronizing a plurality of time-keeping devices, the method comprising the steps of:
receiving, at a primary clock device, a long-range wireless reference time signal;
updating a master time maintained by the primary clock device based upon the reference time signal;
wirelessly broadcasting the master time from the primary clock device to the plurality of time-keeping devices as a short-range signal;
receiving, at a controller of a time-keeping device, the broadcast master time;
converting the broadcast master time to a synchronized time code;
transmitting the synchronized time code from the controller to a clock movement of the time-keeping device; and
updating the time-keeping device based upon the synchronized time code, thereby synchronizing the plurality of time-keeping devices with the master time and reference time signal.

17. The method of claim 16, wherein the long-range wireless reference time signal is a global positioning system-based (GPS) signal.

18. The method of claim 16, wherein the master time is wirelessly broadcast in a short-range spread spectrum signal.

19. The method of claim 18, wherein the short-range spread spectrum signal is broadcast in a band of about 902 megahertz to about 928 megahertz.

20. The method of claim 17, wherein the synchronized time code is a WWVB radio signal format.

21. The method of claim 17, wherein the time-keeping device is an analog clock adapted for wall-mounting and the clock movement is an analog clock movement including hour, minute, and second indicators.

22. The method of claim 17, further comprising the step of wirelessly transmitting information from the time-keeping device to the primary clock device.

23. A synchronized clock system comprising:
a primary clock device comprising receiver circuitry adapted to receive a long-range wireless reference time signal, a primary controller in electrical communication with the receiver circuitry and adapted to maintain a system time based upon the reference time signal, and transmitter circuitry in electrical communication with the primary controller and adapted to broadcast a system time signal; and
at least one secondary clock device comprising a secondary controller in electrical communication with a clock movement adapted to receive a synchronized time code, the secondary controller including an adapter module comprising receiver circuitry to receive the system time signal;
wherein the secondary controller is operable to encode a received system time signal as a synchronized time code and transmit the synchronized time code to the clock movement, and wherein the clock movement is adapted to achieve system time synchronization after receiving the synchronized time code.

24. The clock system of claim 23, wherein the system time signal is broadcast by the transmitter circuitry as a short-range wireless spread spectrum signal.

25. The clock system of claim 24, wherein the short-range wireless spread spectrum signal is broadcast in a band of about 902 megahertz to about 928 megahertz.

26. The clock system of claim 24, wherein the system time signal is broadcast by the transmitter circuitry on a wired network, and wherein the adapter module is configured to operably connect to the wired network.

27. The system of claim 24, wherein the long-range wireless reference time signal comprises a global positioning system-based (GPS) signal.

28. The system of claim 24, wherein the primary clock device further comprises a liquid crystal display (LCD) for displaying the system time.

29. The system of claim 28, wherein the primary clock device further comprises an external keypad for programming the primary clock device.

30. The system of claim 24, wherein the primary clock device further comprises an external computer interface for connection to a computer.

31. The system of claim 24, wherein the synchronized time code is a WWVB radio signal format.

32. The system of claim 24, wherein the at least one secondary clock device comprises an analog clock having a case configured for wall-mounting, and wherein the movement comprises an analog clock movement having hour, minute, and second indicators.

33. The system of claim 24, wherein the at least one secondary clock device comprises a plurality of secondary clock devices, and wherein at least one of the plurality of secondary clock devices omits the secondary controller and is configured to receive the system time signal and directly achieve system time synchronization from the system time signal.

34. The system of claim 33, wherein the long-range wireless reference time signal comprises a global positioning system-based (GPS) signal, and wherein the system time signal is broadcast by the transmitter circuitry as a short-range wireless spread spectrum signal.

35. A primary clock device comprising:
a receiver including an antenna and adapted to wirelessly receive a long-range reference time signal;
a microcontroller in electrical communication with the receiver and including an internal time-keeping device to maintain a master time based upon the long-range reference time signal; and
spread spectrum transmitter in electrical communication with the microcontroller and operable to receive the master time from the microcontroller and wirelessly transmit the master time as a short-range spread spectrum signal.

36. The primary clock device of claim 35, wherein the long-range reference time signal comprises a global positioning system (GPS) signal.

37. The primary clock device of claim 35, wherein the short-range spread spectrum signal is broadcast in the band of about 902 megahertz to about 928 megahertz.

38. The primary clock device of claim 35 further comprising a liquid crystal display (LCD) for displaying the master time.

39. The primary clock device of claim 38 further comprising an external keypad in electrical communication with the microcontroller for programming the primary clock device.

40. A secondary clock device comprising:
a spread spectrum receiver adapted to receive a wireless short-range spread spectrum time synchronization signal;
a controller in electrical communication with the receiver to receive the time synchronization signal and determine a time correction; and
an analog clock movement, the analog clock movement comprising an hour, a minute, and a second indicator disposed on a clock display enclosed in a housing, wherein the analog clock movement is adapted to receive a time correction signal from the controller and is operable to update the hour, minute, and second indicators in accordance with the time correction signal.

41. The secondary clock device of claim 40, wherein the housing is adapted for wall hanging.

42. The secondary clock device of claim 40, wherein the short-range spread spectrum signal is in the band of about 902 megahertz to about 928 megahertz.

43. The secondary clock device of claim 40, wherein the analog clock movement is configured to receive a WWVB radio signal format time correction signal, and wherein the controller further comprises a microprocessor operable to translate the time correction into a WWVB radio signal format time correction signal and transmit the WWVB radio signal format time correction signal to the analog clock movement.

44. A secondary clock device comprising:
an adapter module including a first receiver in electrical communication with a microcontroller, wherein the first receiver is adapted to receive a time synchronization signal; and
an analog clock movement, the analog clock movement comprising an hour, a minute, and a second indicator disposed on a clock display enclosed in a housing, wherein the analog clock movement is in electrical communication with the adapter module to receive a time correction signal calculated by the microcontroller based upon the time synchronization signal, and wherein the analog clock movement is operable to update the hour, minute, and second indicators in accordance with the time correction signal.

45. The secondary clock device of claim 44, wherein the first receiver comprises a spread spectrum receiver adapted to receive a wireless short-range spread spectrum time synchronization signal.

46. The secondary clock device of claim 45, wherein the short-range spread spectrum signal is in the band of about 902 megahertz to about 928 megahertz.

47. The secondary clock device of claim 45 further comprising a second receiver comprising a long-range signal receiver, wherein the secondary clock device is adapted to switch between the first receiver and the second receiver based upon time synchronization signal availability.

48. The secondary clock device of claim 47, wherein the housing is adapted for wall-mounting.

49. The secondary clock device of claim 44, wherein the first receiver comprises a long-range signal receiver.

50. The secondary clock device of claim 49, wherein the time synchronization signal comprises a global positioning system (GPS) signal.

51. A clock adapter module comprising:
a receiver adapted to receive a short-range spread spectrum reference time signal;
a microcontroller in electrical communication with the receiver; and
an analog clock movement interface adapted to couple the clock adapter module a secondary analog clock movement;
wherein the microcontroller is configured to receive the short-range spread spectrum reference time signal from the receiver, convert the short-range spread spectrum reference time signal to a long-range reference time signal format signal, and transmit the long-range reference time signal format signal to the secondary analog clock movement via the analog clock movement interface to synchronize the analog clock movement to a nearest second.

52. A method of creating a primary-secondary clock system comprising the steps of:
providing a primary clock, wherein the primary clock comprises
a primary receiver including an antenna and adapted to receive a wireless long-range reference time signal,
a primary microcontroller in electrical communication with the primary receiver and including an internal time-keeping device to maintain a master time based upon the long-range reference time signal, and
spread spectrum transmitter in electrical communication with the primary microcontroller and operable to receive the master time from the primary microcontroller and wirelessly transmit the master time as a short-range spread spectrum signal;
providing a plurality of secondary clocks, wherein each of the plurality of the secondary clocks comprises
a first receiver adapted to receive a wireless long-range reference time signal and in electrical communication with a secondary microcontroller,
an adapter module including a second receiver in electrical communication with the secondary microcontroller, wherein the second receiver is adapted to receive a short-range spread spectrum signal, and
an analog clock movement, the analog clock movement comprising an hour, a minute, and a second indicator disposed on a clock display enclosed in a housing, wherein the analog clock movement is in electrical communication with the secondary microcontroller to receive a time correction signal calculated by the secondary microcontroller;
determining, at the secondary microcontroller, whether the first receiver received a wireless long-range reference time signal;
if a long-range reference time signal was received, calculating the time correction signal based upon the long-range reference time signal and transmitting the time correction signal to the analog clock movement to synchronize the analog clock movement with the long-range reference time signal; and
if a long-range reference time signal was not received, using the adapter module to receive a short-range spread spectrum signal from the primary clock, calculating the time correction signal based upon the short-range spread spectrum signal, and transmitting the time correction signal to the analog clock movement to synchronize the analog clock movement with the short-range spread spectrum signal.

53. The method of claim 52, wherein the long-range reference time signal comprises a global positioning system (GPS) signal, and wherein the short-range spread spectrum signal is in the band of about 902 megahertz to about 928 megahertz.

54. The method of claim 52, wherein the housing is adapted for wall-mounting.
